(19) United States
(12) Patent Application Publication
(10) Pub. No.: US 2015/0140302 A1
(43) Pub. Date: May 21, 2015

(54) HIGH-RESISTANCE LAMINATE AND TACTILE SENSOR-USE FRONT PLATE

(71) Applicant: Senseg Ltd., Espoo (FI)

(72) Inventors: Kensuke FUJII, Tokyo (JP); Kouji SATOU, Tokyo (JP)

(73) Assignee: Senseg Ltd., Espoo (FI)

(21) Appl. No.: 14/316,120

(22) Filed: Jun. 26, 2014

Related U.S. Application Data
(63) Continuation of application No. PCT/JP2012/082832, filed on Dec. 18, 2012.

(30) Foreign Application Priority Data
Dec. 26, 2011 (JP) 2011-283809

(51) Int. Cl. B32B 7/02; B32B 9/00

(52) U.S. Cl. CPC B32B 7/02; B32B 9/005; B32B 2250/42; B32B 2307/206; B32B 2307/412; B32B 2457/208
USPC 428/216; 428/702; 428/332; 428/212

(57) ABSTRACT

A high-resistance laminate includes a transparent substrate and a high-resistance layer formed upon the transparent substrate. The high-resistance layer contains an oxide that includes tin and titanium as main components. The atomic ratio of the tin to the titanium (Sn/Ti) is 80/20 to 95/5, and the surface resistivity value of the high-resistance layer is 1 to 100 megaohms per square. A barrier layer can be interposed between the transparent substrate and the high-resistance layer. This high-resistance laminate may form all or part of a high-resistance layer within a front panel for a tactile sensor. Such a tactile sensor may include the high resistance layer and an insulating layer.

### TECHNICAL FIELD

The present invention relates to a high-resistance laminate, and a front panel for a tactile sensor using the high-resistance laminate.

### BACKGROUND ART

In recent years, a touch panel display device (interface device) provided with a touch panel display operated by directly touching a touch panel by fingers or the like has been used as an input device or an input/output device.

In a touch panel display device used as an input device or an input/output device, an input screen can be freely constituted by use of software. Therefore, the device has flexibility which can not be obtained with an input device constituted by use of mechanical switches, and in addition, it can be constituted to be light in weight and compact in form, and is low in frequency of occurrence of mechanical failures. Due to these advantageous, at present, touch panel display devices are widely used ranging from operation panels for relatively large machines to input/output devices for very small portable apparatus.

Many of touch panel display devices are so designed that the user's fingertip operating the touch panel display device only touches a flat and smooth panel surface. Therefore, the touch panel display devices do not give a click feeling such as those sensed by a fingertip operating an input device constituted by use of mechanical switches. This has been the cause of the indefinite feeling in operating a touch panel display device. To solve this problem, a touch panel display device provided with a so-called tactile sensor, in which the sense of touch is fed back to the user's fingertip operating the touch panel display has been disclosed (for example, Patent Document 1).

The touch panel display device is so configured that a touch panel touched by the user's fingertip is vibrated, whereby the sense of touch is provided for the user.

In addition to one so designed that the sense of touch is fed back by the mechanical stimulation, a technique to give the sense of touch for the user by an electrical sense by controlling the electric charge of a front panel such as a protective film, which is to be provided in front of a touch panel has been known (for example, Patent Document 2).

In Patent Document 2, to conducting electrodes each provided with an insulator, a predetermined electrical input is applied from a voltage source to form electrostatic force (capacitive coupling) in a region between the conductive electrodes and the body, whereby an electrical sense is generated.

As such a constitution, for example, Non-Patent Document 1 discloses a touch panel having a transparent electrode layered on a glass substrate, covered with an insulating layer.

A device as disclosed in Patent Document 2 or Non-Patent Document 1 is specifically, as shown in FIG. 6, so constituted that the voltage and the frequency are controlled in a pattern capable of reproducing the tactile feeling to be expressed, and electricity is applied to a transparent electrode (not shown) on a touch panel main body 100 from a control part not shown, and the electric charge induced on a front panel 101 side is accumulated on a layer 103 formed upon a transparent substrate 102, so that the front panel 101 will be charged. When a sensory receptor X such as a finger 105 is contacted to the surface of the front panel 101 in such a charged state, a weak electrostatic force works between them by means of an insulating layer 104, which is perceived by the sensory receptor X as the tactile feeling such as a concave-convex touch feeling.

As a front panel 101 to be provided on such a touch panel display device provided with a so-called tactile sensor, one which will not inhibit the operation of the transparent substrate provided on the touch panel main body 100, which accurately develops the charged state based on the voltage or the frequency fed from the control unit, and which can develop the desired sense of touch with good reproducibility, has been desired. Particularly, for accurately developing the charged state, it has been desired to control the resistivity of the layer 103 on which the electric charge is to be accumulated precisely within a predetermined range.

On the other hand, the front panel 101 is required to improve transmittance and reduce reflectance to light in the visible range in order to secure the visibility, as it is provided in front of the touch panel main body 100 which shows images. Further, the front panel 101 is required to have a hardness which can withstand a certain level of pressing force and have moderate smoothness, since it is operated by being pressed or rubbed directly by a finger 105 or the like.

However, a front panel to be provided on such a touch panel, which excellently develops the sense of touch, which has a favorable light transmittance and a low reflectance to light in the visible region, and which has sufficient hardness and smoothness as well, has not yet been obtained. Conventional front panels likely have problems: insufficient sensitivity as a sensor or poor visibility and operability.

### PRIOR ART DOCUMENTS

### Patent Documents

Patent Document 1: JP-A-2003-288158
Patent Document 2: JP-A-2009-87359

### Non-Patent Document

Non-Patent Document 1: http://www.disneyresearch.com/research/projects/teslatouchuist2010.pdf

### SUMMARY OF INVENTION

### Technical Problem

The present invention has been made to solve the above problems. An object of the present invention is to provide a front panel for a tactile sensor which has favorable sensitivity detected by touch, which has a high light transmittance and a low reflectance to light in the visible region, and which is excellent in the visibility and the operability. Another object of the present invention is to provide a high-resistance laminate for obtaining such a front panel for a tactile sensor.

### Solution to Problem

The high-resistance laminate of the present invention is a high-resistance laminate comprising a transparent substrate and a high-resistance layer formed upon the transparent substrate, wherein the high-resistance layer comprises an oxide including tin and titanium as main components, wherein the atomic ratio of the tin to the titanium (Sn/Ti) is 80/20 to 95/5, and the surface resistivity value of the high-resistance layer is 1 to 100 MΩ/□.

In the high-resistance laminate of the present invention, a barrier layer can be interposed between the transparent substrate and the high-resistance layer.

The front panel for a tactile sensor of the present invention is a front panel for a tactile sensor wherein a high-resistance layer and an insulating layer are layered on a transparent substrate in the stated order, wherein the high-resistance layer comprises an oxide including tin and titanium as main components, wherein the atomic ratio of the tin to the titanium (Sn/Ti) is 80/20 to 95/5, and the surface resistivity value of the high-resistance layer is 1 to 100 MΩ/□.

It is preferred that the luminous transmittance of the front panel for a tactile sensor of the present invention is at least 85%. Further, in the front panel for a tactile sensor of the present invention, a barrier layer can be interposed between the transparent substrate and the high-resistance layer. Further, it is preferred that the static friction coefficient of the front panel for a tactile sensor of the present invention is at most 0.2. The dynamic friction coefficient is preferably at most 0.2 and the water contact angle is preferably at least 80 degrees. Further, the luminous reflectance of the front panel for a tactile sensor of the present invention is preferably at most 7%. Further, it is preferred that the refractive index of the high-resistance layer is 1.8 to 2.5 and the thickness of the high-resistance layer is 5 to 100 nm. Further, the refractive index of the insulating layer is preferably 1.3 to 1.8. Further, it is preferred that the material of the insulating layer is inorganic oxide and the thickness of the insulating layer is 50 nm to 5 μm. Further, it is preferred that the insulating layer is a layer formed by hardening an insulator composition of ultraviolet-cure type or an insulator composition of heat-cure type and the thickness of the insulating layer is 1 to 100 μm.

In the specification, the “main component” refers to a structural component having a content of more than 50 mass %. For example, the high-resistance layer comprising an oxide including tin and titanium as main components refers to a high-resistance layer containing more than 50 mass % of the oxide including tin and titanium. Further, “transparent” refers to allowing visible light to pass through.

The “to” used in showing the numerical value range mentioned above means that the numerical values before and after the “to” are included as the lower limit and the upper limit and hereinafter used in the same sense in the specification unless otherwise specified.

### Advantageous Effects of Invention

According to the high-resistance laminate of the present invention, since a high-resistance layer comprising an oxide including tin and titanium as main components, an atomic ratio of the tin to the titanium (Sn/Ti) within the predetermined range (80/20 to 95/5), and a surface resistivity value of 1 to 100 MΩ/□ is layered on a transparent substrate, a favorable sensor sensitivity detectable by touch can be realized.

According to the front panel for a tactile sensor of the present invention wherein a high-resistance layer and an insulating layer are layered on a transparent substrate in the stated order, since the high-resistance layer comprises an oxide including tin and titanium as main components; the atomic ratio of the tin to the titanium (Sn/Ti) in the layer is adjusted to be within the predetermined range; and the surface resistivity value of the high-resistance layer is 1 to 100 MΩ/□, whereby a favorable sensor sensitivity detectable by touch and excellent visibility and operability can be attained.

### BRIEF DESCRIPTION OF DRAWINGS

FIG. 1 is a cross sectional view showing one example of a high-resistance laminate according to a first embodiment of the present invention.

FIG. 2 is a cross sectional view showing another example of the high-resistance laminate of the present invention.

FIG. 3 is a cross sectional view showing one example of a front panel for a tactile sensor according to a second embodiment of the present invention.

FIG. 4 is a cross sectional view showing a state where a front panel for a tactile sensor of the present invention is disposed on a touch panel main body.

FIG. 5 is a cross sectional view showing another example of the front panel for a tactile sensor of the present invention.

FIG. 6 is a view schematically illustrating a state where a fingertip is close to the surface of a touch panel provided with a front panel for a tactile sensor.

### DESCRIPTION OF EMBODIMENTS

Now, embodiments of the present invention will be described. The present invention is not limited to the following embodiments.

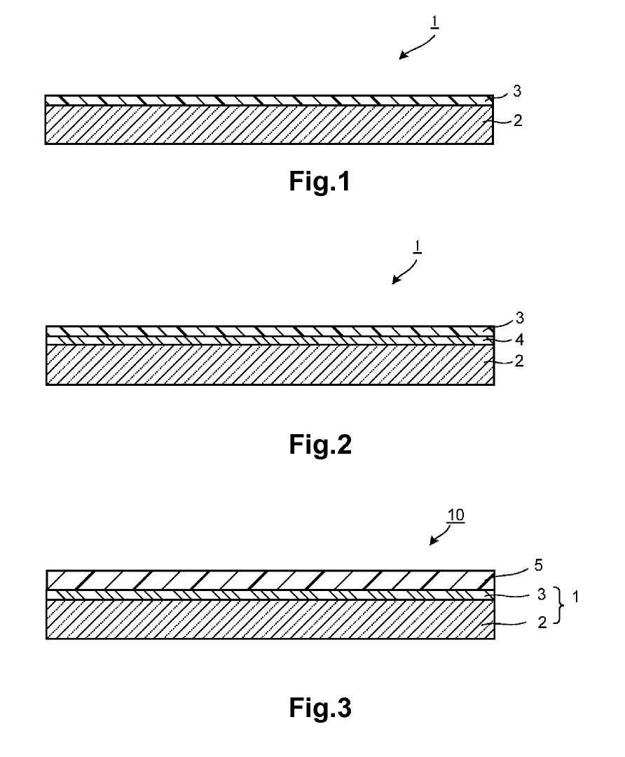

FIG. 1 is a cross sectional view showing one example of a high-resistance laminate according to a first embodiment of the present invention.

As shown in FIG. 1, a high-resistance laminate 1 of the first embodiment has a transparent substrate 2 and a high-resistance layer 3 layered on the transparent substrate 2. The high-resistance layer 3 comprises an oxide including tin and titanium as main components and the atomic ratio of the tin to the titanium (Sn/Ti) in the high-resistance layer 3 is adjusted to be in the range of 80/20 to 95/5. Further, the surface resistivity value (also referred to as a sheet resistivity) of the high-resistance layer 3 is 1 to 100 MΩ/□.

According to such a high-resistance laminate 1, it is preferred that the surface resistivity value of the high-resistance layer 3 is 1 to 100 MΩ/□, since when the high-resistance layer 3 is used as a front panel for a tactile sensor by providing an insulating layer thereon, as described later, a sense of touch based on electric signals such as voltage or frequency, which were fed to a control unit, can be developed with good reproducibility and excellent sensor sensitivity can be obtained without inhibiting the operation of transparent electrodes provided to underlying touch panel main body.

Now, the transparent substrate 2 and the high-resistance layer 3 constituting the high-resistance laminate 1 of the embodiment will be described.

### [Transparent Substrate]

The transparent substrate 2 is not particularly limited so long as it is smooth and is transparent to visible light.

Specifically, it may, for example, be a transparent glass plate made of glass such as transparent and colorless soda lime silicate glass, aluminosilicate glass (SiO₂—Al₂O₃—Na₂O type glass), lithium aluminosilicate glass, quartz glass or alkali-free glass; a tempered glass plate obtained by applying a chemical tempering treatment to the surface of a transparent glass plate as mentioned above; or a plastic film such as a single-layer plastic film formed of a plastic material selected from polyethylene terephthalate, polycarbonate, triacetyl cellulose, polyether sulfone, polymethyl methacrylate, a cycloolefin polymer, and the like, or a multi-layer plastic film formed of a plurality types of plastic materials as mentioned above.

The transparent substrate 2 is preferably a soda lime silicate glass plate from the viewpoint of the adhesion to a layer to be provided thereon. Further, in view of strength, it is preferably a tempered glass plate obtained by tempering an aluminosilicate glass plate (for example, “Dragontrail” (tradename) manufactured by Asahi Glass Company, Limited).

In the case where the high-resistance laminate 1 of the present invention is used as a front panel for a tactile sensor, it is preferred that the transparent substrate 2 has sufficient strength, in consideration of the use pattern. Accordingly, the transparent substrate 2 is preferably a tempered glass plate obtained by tempering an aluminosilicate glass plate, for example, a chemically tempered glass plate. The glass material constituting the aluminosilicate glass plate may, for example, be the following glass material. That is, a glass material containing 50 to 80% of SiO₂, 1 to 20% of Al₂O₂, 6 to 20% of Na₂O, 0 to 11% of K₂O, 0 to 15% of MgO, 0 to 6% of CaO and 0 to 5% of ZrO₂, (the percentages of these oxides are represented by mol %) is used.

On the surface of a tempered glass plate obtained by subjecting an aluminosilicate glass to a chemical tempering treatment, a compressive stress layer is formed, and the thickness of the compressive stress layer is preferably at least 10 μm, more preferably at least 30 μm. Further, the surface compressive stress of the compressive stress layer is preferably at least 200 MPa, more preferably at least 550 MPa. The method of applying a chemical tempering treatment to an aluminosilicate glass plate may be typically a method of immersing an aluminosilicate glass plate in a KNO₃ molten salt to carry out ion exchange treatment, and then cooling it to the vicinity of room temperature. Treatment conditions such as the temperature of the KNO₃ molten salt and the immersion time are set so that desired surface compressive stress and thickness of the compressive stress layer are obtained.

Further, in the case where a plastic film as mentioned above is used as the transparent substrate 2, a polyethylene terephthalate film is preferably used.

The thickness of the transparent substrate 2 is not particularly limited, and is preferably from 0.1 to 2 mm, more preferably from 0.3 to 1 mm, in a case where the transparent substrate 2 is constituted by the above-described glass substrate. When the thickness of the transparent substrate 2 beyond 2 mm is used as the front panel for a tactile sensor, the pressing force applied to the surface of the substrate is not easily transmitted to the underlying panel main body, with the result that operability may decrease. Further, when the thickness of the transparent substrate 2 is less than 0.5 mm, strength and upper-layer holding performance are too low to obtain a laminate.

In a case where the transparent substrate 2 is constituted by the above-described plastic film, its thickness is preferably from 50 to 200 μm. The transparent substrate 2 may be constituted of a single layer or may be a laminate constituted of a plurality of layers.

### [High-Resistance Layer]

The high-resistance layer 3 is a layer having a surface resistivity value (sheet resistivity value) of 1 to 100 MΩ/□. The high-resistance layer 3, when it is used as a part of a front panel for a tactile sensor, accumulates the electric charges, which are induced on the side of the front panel for a tactile sensor by applying electricity to transparent electrodes provided on the touch panel main body disposed below the transparent substrate 2.

When the surface resistivity value of the high-resistance layer 3 is at least 1 MΩ/□, it is possible to prevent the operation of the touch panel main body from being inhibited by electrical interaction of the high-resistance layer 3 with the transparent electrodes when electricity is applied to the transparent electrodes of the touch panel main body. Further, it is preferred that the surface resistivity value of the high-resistance layer 3 is at most 100 MΩ/□, since the charged state based on the control voltage and the frequency is accurately developed, whereby the desired sense of touch can be developed with good reproducibility to a sensory receptor such as a finger, whereby an excellent sensor sensitivity by the sense of touch can be obtained.

Further, the high-resistance layer 3 uses an oxide including tin and titanium as main components. Further, the atomic ratio of the tin to the titanium (Sn/Ti) in the high-resistance layer 3 is preferably 80/20 to 95/5, more preferably between 85/15 and 95/5.

It is preferred that the high-resistance layer 3 uses an oxide including tin and titanium as main components, since the surface resistivity value of the high-resistance layer 3 can easily be adjusted to be within the above preferred range, and also since titanium serves as a scattering substance for electrons in a tin oxide to obtain a stable high surface resistivity value without dependence on the thickness of the high-resistance layer 3.

Further, when the atomic ratio of the tin to the titanium (Sn/Ti) in the high-resistance layer 3 falls within the range, the surface resistivity value of the high-resistance layer 3 can easily be controlled to be within the above preferred range, and further the refractive index thereof can be controlled to be an appropriate value. Further it is preferred that a front panel for a tactile sensor has an insulating layer on the high-resistance layer 3, since favorable luminous transmittance and low luminous reflectance can be obtained.

Here, titanium contained in the high-resistance layer 3 has the same tetravalent element as tin and is not effective as a dopant. In addition, since the ion radius of titanium in the high-resistance layer 3 greatly differs from that of tin, it is considered that titanium effectively works as a scattering substance for electrons of tin oxide in the high-resistance layer 3. As a result, it is considered that a mean free path of electrons in tin oxide is shortened to successfully increase the resistance.

As the high-resistance layer 3, a layer comprising an oxide including tin and titanium as main components is preferably used since surface resistivity value can easily be controlled to be within the above preferred range while maintaining favorable light transmittance. Particularly, it is preferred that an oxide mentioned above is used as the main component of the high-resistance layer 3, since stable surface resistivity value can be obtained without dependence on the thickness of the high-resistance layer 3, as mentioned above.

The high-resistance layer 3 of the present invention may be formed upon the transparent substrate 2 comprising e.g. a glass substrate, by sputtering such as DC (direct current) sputtering, AC (alternate current) sputtering or RF (radio-frequency) sputtering. Among them, DC magnetron sputtering or AC sputtering is a film formation method advantageous in view of controlling thickness, since the process is stably conducted and operation can easily be made because a direct current power supply or an alternate current power supply having a simple structure is used. Further, the film formation method is preferably used since film formation on a large area is easy. Here, the DC magnetron sputtering method includes a method of applying a pulsed voltage. Such a pulsed DC magnetron sputtering is effective to prevent abnormal electric discharge.

For formation of the high-resistance layer 3, a so-called co-sputtering employing a plurality of targets can be employed. Co-sputtering is conducted by simultaneously discharging on a plurality of targets. A coating film having a desired composition can be formed by controlling the power density to be applied to each target and the partial pressure of a sputtering gas.

In a case where the high-resistance layer 3 comprising an oxide including tin and titanium as main components is formed by co-sputtering, a target containing tin or tin oxide as the main component and a target containing titanium or titanium oxide as the main component are used as targets.

The metal target containing tin as the main component may be one consisting solely of tin, or one containing tin as the main component doped with a known dopant such as Al, Si and Zn, within a range not to impair the effects of the present invention. The target containing tin oxide as the main component may be one containing tin oxide as the main component doped with a known dopant such as Al, Si and Zn, within a range not to impair the effects of the present invention. Here, the target containing tin oxide as the main component may be preferably a tin oxide target containing gallium, indium and oxides of these, which provide conductivity to the tin oxide and increase the efficiency of DC sputtering.

The metal target containing titanium as the main component may be one consisting solely of titanium, or one containing titanium as the main component doped with a known dopant other than titanium within a range not to impair the effects of the present invention. The target containing titanium oxide as the main component may be one containing titanium oxide as the main component doped with a known dopant other than titanium oxide within a range not to impair the effects of the present invention.

Sputtering can be made by using a target containing tin oxide as the main component and a target containing titanium oxide as the main component in combination, so as to obtain the composition of a desired high-resistance layer 3 in an atmosphere of an inert gas (described later) containing substantially no reactive gas.

As the sputtering gas, various reactive gases may be used. For example, oxygen gas, a mixed gas of oxygen gas with an inert gas, or a mixed gas of a nitrogen gas and an inert gas may be used. The inert gas may, for example, be a rare gas such as helium, neon, argon, krypton or xenon. Among them, preferred is argon in view of the economical efficiency and the easiness of electric discharge. Further, as the sputtering gas, a gas containing a nitrogen atom such as N₂O, NO, NO₂ or NH₃ can be used other than nitrogen gas (N₂). These gases may be used alone or as a mixture of two or more.

In the case where a layer comprising an oxide of tin and titanium as main components is formed by reactive sputtering using a target containing tin or tin oxide as the main component and a target containing titanium or titanium oxide as the main component, the composition of the oxide layer can be controlled if the sputtering is conducted under an oxidative atmosphere. Here, the oxidative atmosphere is an atmosphere containing an oxidative gas in an inert gas. The oxidative gas refers to a gas containing an oxygen atom such as O₂, H₂O, CO or CO₂. The concentration of the oxidative gas significantly influences properties of the oxide layer such as conductivity and light transmittance. Thus, it is necessary to optimize the concentration of an oxidative gas depending upon the conditions to be used such as an apparatus, a substrate temperature, a sputtering pressure.

A sputtering gas such as Ar—O₂ gas (mixed gas of Ar and O₂) is particularly preferable since the composition of the gas can easily be controlled. The concentration of O₂ in the Ar—O₂ gas is preferably 0.5 to 50 vol % since a transparent and high-resistance film can be obtained. The partial pressures of the oxygen and the inert gas such as Ar in the sputtering gas and the total pressure of the sputtering gas are not particularly limited so long as the glow discharge is stably conducted.

In a case where the high-resistance layer 3 is formed by co-sputtering, the power density of each target (a value obtained by dividing power supply by the area of a target) is preferably 0.9 to 4 W/cm², more preferably 0.9 to 3 W/cm². When the power density is less than 0.9 W/cm², discharge is not stably made. When the power density exceeds 4 W/cm², a target may be broken by the heat generated. The sputtering pressure is preferably 0.1 Pa to 1 Pa. A pressure of at most 1 Pa and at least 0.1 Pa is preferable since discharge tends to be stably made.

Further, the temperature of the transparent substrate 2 in sputtering is preferably 10 to 250° C., more preferably 25 to 250° C. The temperature is preferably at most 250° C. since the film composition does not significantly differ from that target composition. The film deposition time may be determined depending upon the deposition rate and the desired thickness.

When co-sputtering is conducted in this manner, the high-resistance layer 3 comprising an oxide including tin and titanium as main components, wherein the atomic ratio of the tin to the titanium (Sn/Ti) is 80/20 to 95/5 can be formed. However, formation of the high-resistance layer 3 is not limited to a sputtering method as mentioned above, and may be carried out by a physical vapor deposition method such as a vacuum deposition method, an ion beam assisted deposition method or an ion plating method or a chemical vapor deposition method such as a plasma CVD method can be used.

The thickness of the high-resistance layer 3 is preferably 5 to 100 nm, more preferably 5 to 50 nm, further preferably 5 to 30 nm. It is preferred that the thickness of the high-resistance layer 3 is at least 5 nm, since a sufficient charge retention function can be obtained. Further, it is preferred that the thickness of the high-resistance layer 3 is at most 100 nm, since a favorable transmittance to visible light can be obtained. In the present specification, the “thickness” of each layer is a thickness obtained by measurement by a stylus surface profiler.

In the front panel for a tactile sensor (described later), the refractive index (n) of the high-resistance layer 3 is preferably 1.8 to 2.5 with a view to obtaining excellent optical properties such as the luminous transmittance and the luminous reflectance.

Further, the high-resistance laminate is not limited to that shown in FIG. 2, and may have a barrier layer 4 interposed between the transparent substrate 2 and the high-resistance layer 3 as shown in FIG. 3. By the presence of the barrier layer 4 interposed between the transparent substrate 2 and the high-resistance layer 3, it is possible to suppress diffusion of components contained in the transparent substrate 2 into the high-resistance layer 3 and suppress a change of resistivity or the like of the high-resistance layer 3 with time. In addition, the effect of the surface shape of transparent substrate 2 such as glass substrate can be suppressed and the resistivity of the high-resistance layer 3 can be stabilized.

The barrier layer 4 may, for example, be a layer containing silicon oxide as the main component or a layer containing silicon oxide and indium oxide as the main component. Among them, the layer containing silicon oxide as the main component is preferred, whereby favorable light transmittance will easily be secured. Further, among layers containing silicon oxide as the main component, a layer which further contains nitrogen, for example, a layer containing silicon oxynitride (SiON) is more preferred, whereby excellent light transmittance can be obtained and in addition, an effect of reducing the luminous reflectance of the front panel for a tactile sensor can be obtained.

The layer containing silicon oxide as the main component may be a layer consisting solely of silicon oxide, or a layer containing silicon oxide as the main component and containing at least one member selected from boron and phosphorus as an added element other than silicon.

The barrier layer 4 may be formed upon the transparent substrate 2 by sputtering such as DC sputtering such as DC magnetron sputtering, AC sputtering or RF sputtering in the same manner as formation of the high-resistance layer 3.

In a case where the barrier layer 4 is a layer containing silicon oxide as the main component, the target to be used for formation of the barrier layer 4 may be a target containing silicon as the main component. The target containing silicon as the main component may be one consisting solely of silicon, or may be one containing silicon as the main component doped with an element other than silicon, for example, a known dopant such as boron or phosphorus, within a range not to impair the effects of the present invention.

Formation of the barrier layer 4 by sputtering may be carried out by properly adjusting the conditions such as the pressure of the sputtering gas and the film deposition rate, in the same manner as sputtering for the high-resistance layer 3.

In a case where a layer containing silicon oxide as the main component and further containing nitrogen, for example, a layer containing a silicon oxynitride (SiOn) is formed as the barrier layer 4, such a layer may be formed by using, as the sputtering gas, for example, a mixed gas having an oxygen gas and an inert gas mixed with a nitrogen gas or with a mixed gas having a nitrogen atom-containing gas such as N₂O, NO, NO₂ or NH₃.

The method for forming the barrier layer 4 comprising e.g. a silicon oxide is not limited to the above sputtering method, for example, a physical vapor deposition method other than the sputtering method, such as a vacuum deposition method, an ion beam assisted deposition method or an ion plating method, or a chemical vapor deposition method such as a plasma CVD method can be used.

The thickness of the barrier layer 4 is preferably at most 100 nm, more preferably at most 50 nm, further preferably at most 30 nm. It is preferred that the thickness of the barrier layer 4 is at most 100 nm since a front panel for a tactile sensor having an appropriate bending strength and sufficient light transmittance can be obtained. The thickness of the barrier layer 4 is preferably at least 2 nm with a view to obtaining a barrier effect as a continuous film.

In the front panel for a tactile sensor (described later), the refractive index (n) of the barrier layer 4 is preferably 1.4 to 2.0 with a view to obtaining excellent optical properties such as luminous transmittance and luminous reflectance.

Now, a front panel for a tactile sensor according to a second embodiment of the present invention will be described. FIG. 3 is a cross sectional view showing one example of a front panel for a tactile sensor according to a second embodiment.

The front panel 10 for a tactile sensor has a structure in which the high-resistance layer 3 and the insulating layer 5 are layered on the transparent substrate 2 in the stated order. The high-resistance layer 3 comprises an oxide including tin and titanium as main components and the atomic ratio of the tin to the titanium (Sn/Ti) in the high-resistance layer 3 is 80/20 to 95/5. Further, the surface resistivity value of the high-resistance layer 3 is 1 to 100 MΩ/□.

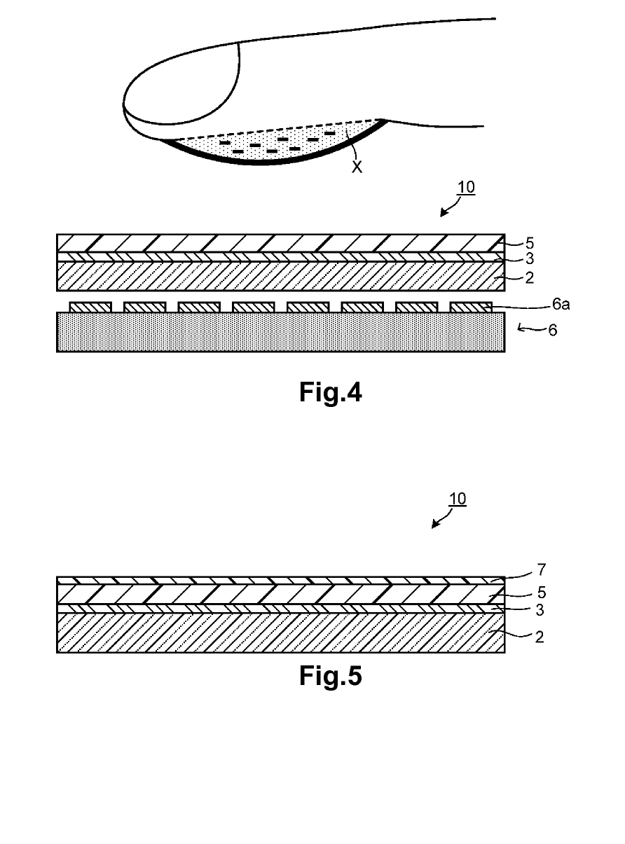

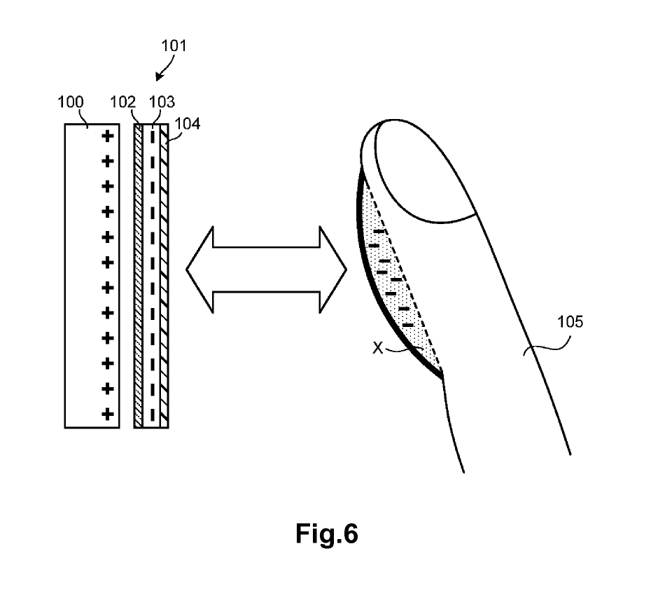

Such a front panel 10 for a tactile sensor is to be provided in front of the touch panel main body 6 as shown in FIG. 4, for example. Electricity is applied to transparent electrodes 6a of the touch panel main body 6 from a control unit not shown at a voltage and frequency controlled in a pattern capable of reproducing the tactile feeling to be expressed, and the electric charge induced on the side of the front panel 10 for a tactile sensor is accumulated on the high-resistance layer 3, whereby the front panel 10 for a tactile sensor is charged. When a sensory receptor X such as a finger is touched to the surface of the front panel 10 for a tactile sensor in such a charged state, a weak electrostatic force works between them by means of the insulating layer 5, which is perceived by the sensory receptor X as the sense of touch such as the concave-convex touch feeling.

According to such a front panel 10 for a tactile sensor, it is preferred that the surface resistivity value of the high-resistance layer 3 is 1 to 100 MΩ/□, since a sense of touch based on an electric signal such as a voltage and a frequency fed to the control unit can be developed with good reproducibility without inhibiting operation of the transparent electrodes 6a disposed to the touch panel main body 6 and excellent sensor sensitivity can be obtained.

The front panel 10 for a tactile sensor of the second embodiment has a structure in which the insulating layer 5 is layered on the high-resistance layer 3 of the high-resistance laminate 1, according to the first embodiment. In the same manner as in the high-resistance laminate 1, a barrier layer can be interposed between the transparent substrate 2 and the high-resistance layer 3. The luminous transmittance of the front panel 10 for a tactile sensor is preferably at least 85%. It is preferred that the luminous transmittance of the front panel 10 for a tactile sensor is at least 85%, since excellent visibility can be obtained.

Further, the front panel 10 for a tactile sensor may have a transparent electrodes 6a′ (not shown) for driving a touch panel main body. More specifically, in place of providing the transparent electrodes 6a on the touch panel main body 6, the transparent electrodes 6a′ may be provided on the surface opposite to the surface of the front panel 10 for a tactile sensor on which the high-resistance layer 3 of the transparent substrate 2 is provided. By such a constitution, the structure of the touch panel can be simplified; and in addition, the driving voltage can be suppressed to be low, since the distance between the transparent electrode 6a′ and the high-resistance layer 3 tends to be short.

Now, the insulating layer 5, a water repellent layer 7 and the transparent electrodes 6a constituting the front panel 10 for a tactile sensor will be described. Here, the transparent substrate 2, high-resistance layer 3 and barrier layer are constituted in the same manner as in the high-resistance laminate 1 of the first embodiment and thus further explanation will be omitted.

### [Insulating Layer]

The insulating layer 5, which is a layer provided on the upper surface of the high-resistance layer 3 or on the high-resistance layer 3 via another layer, electrically insulates a body portion such as a fingertip in touch with the surface layer of the front panel 10 for a tactile sensor, from the high-resistance layer 3.

In this specification, the insulating layer 5 is a layer having a volume resistivity of at least 10¹⁰ Ω·cm. The volume resistivity is a value measured in accordance with JIS C2318-1975.

The material for constituting the insulating layer 5 is not particularly limited and any material can be used so long as it is transparent to light and has electrical insulating properties. For example, the insulating layer 5 can be constituted of a hardened product obtained by hardening an insulator composition of ultraviolet-cure type (i) (hereinafter the composition will be referred to also as “the insulator composition of ultraviolet-cure type (i)”) by light (UV ray) or an insulator composition of heat-cure type (ii) (hereinafter the composition will be referred to also as “the insulator composition of heat-cure type (ii)”) by heat. Also, the insulating layer 5 can be constituted of an insulating material containing a (iii) inorganic oxide as the main component. Now the material constituting the insulating layer 5 will be described.

<Insulator Composition of Ultraviolet-Cure Type (i)>

As the insulator composition of ultraviolet-cure type (i), for example, a composition containing an ultraviolet curable polymerizable monomer (A), an ultraviolet absorber (B) and a photopolymerization initiator (C) as mentioned below can be used.

### (Ultraviolet Curable Polymerizable Monomer (A))

At least part of the ultraviolet curable polymerizable monomer (A) (hereinafter referred to as a monomer (A)) is preferably a polyfunctional polymerizable monomer (a-1) (hereinafter referred to as monomer (a-1)) having at least two acryloryl groups or methacryloyl groups in one molecule. Here, as the term for representing an acryloyl group or a methacryloyl group, a (meth)acryloyl group is used. The same applies to a (meth)acrylate, (meth)acrylic acid and the like.

The polymerizable functional group is preferably an acryloyl group in view of high polymerizability, particularly high polymerizability by ultraviolet light. Accordingly, preferred as the following compound having (meth)acryloyl groups is a compound having acryloyl groups. Likewise, in the case of the (meth)acrylate, (meth)acrylic acid and the like, preferred is a compound having an acryloyl group. In one molecule of the compound having at least two (meth)acryloyl groups, the polymerizable functional groups may be different from each other (that is, at least one acryloyl group and at least one methacryloyl group may be contained), and preferably all the polymerizable functional groups are acryloyl groups.

The monomer (A) other than the monomer (a-1) may be a monofunctional polymerizable monomer (hereinafter referred to as monomer (a-2)) having one (meth)acryloyl group in one molecule or a compound having at least one ultraviolet curable polymerizable functional group other than the (meth)acryloyl group.

However, the monomer (A), even if it is not the polyfunctional polymerizable monomer (a-1), preferably has a polymerizable functional group selected from an acryloyl group or a methacryloyl group. More specifically, since ultraviolet curable polymerizable functional groups other than a (meth)acryloyl group, which have ultraviolet curing properties but mostly insufficient, are not easily available, a monomer (a-2) is preferable as the monomer (A) other than the monomer (a-1). Accordingly, the monomer (A) preferably comprises substantially only one or more compounds having a (meth)acryloyl group(s) including the monomer (a-1). Hereinafter, the description will be made assuming that all the monomers (A) including the monomer (a-1) are compounds having a (meth)acryloyl group(s).

The monomer (A) may be a compound having a functional group or a bond in addition to the (meth)acryloyl group(s). For example, it may have a hydroxy group, a carboxy group, a halogen atom, a urethane bond, an ether bond, an ester bond, a thioether bond or an amido bond. Particularly preferred is a (meth)acryloyl group-containing compound having a urethane bond (hereinafter referred to as an acrylic urethane) or a (meth)acrylic acid ester compound having no urethane bond.

The monomer (a-2) is a compound usually having no urethane bond, but not limited to it. On the other hand, the monomer (a-1) may or may not have an urethane bond. The average number of (meth)acryloyl groups in one molecule of the monomer (a-1) is not particularly limited and is preferably from 2 to 50, particularly preferably from 2 to 30.

The acrylic urethane is obtainable by a reaction of a compound having a (meth)acryloyl group and a hydroxy group with a compound having an isocyanate group, a reaction of a compound having a (meth)acryloyl group and an isocyanate group with a compound having a hydroxy group and having no (meth)acryloyl group, a reaction of a compound having a (meth)acryloyl group and a hydroxy group, a compound having at least two isocyanate groups and a hydroxy group-containing compound, or the like.

The monofunctional polymerizable monomer i.e. the monomer (a-2) may have a functional group such as a hydroxy group or an epoxy group. Preferred as the monofunctional compound is a (meth)acrylic acid ester i.e. a (meth)acrylate.

The monomers (a-1) may be often preferably used in combination of two or more. It is preferred that at least one monomer (a-1) of them is a compound having 2 to 3 (meth)acryloyl groups; whereas, at least one of the other monomer is a compound having many (meth)acryloyl groups. The former monomer (a-1) is preferably a compound having two (meth)acryloyl groups.

The total proportion of the monomer (a-1) in the monomer (A) is preferably from 20 to 100 mass %, more preferably from 50 to 100 mass %, further preferably from 70 to 100 mass %. When the proportion of the monomer (a-1) is less than this, abrasion resistance may not be sufficient.

### (Ultraviolet Absorber (B))

A part or all of the ultraviolet absorber (B) comprises a polymerizable ultraviolet absorber (b-1). In a case where the amount of the ultraviolet absorber (B) is small, the entire amount preferably comprises the polymerizable ultraviolet absorber (b-1). By use of the polymerizable ultraviolet absorber (b-1), bleeding of the ultraviolet absorber on the surface or a remarkable decrease of the abrasion resistance or the like will not occur even if an ultraviolet absorber in a relatively large amount is incorporated in the insulator composition.

As the polymerizable ultraviolet absorber (b-1), one containing at least one member selected from the following polymerizable benzophenone compounds and polymerizable benzotriazole compounds can be used.

An ultraviolet absorber other than the polymerizable ultraviolet absorber (b-1) may be used in combination as the ultraviolet absorber (B), but use of such another ultraviolet absorber in a large amount is unfavorable. The proportion of the ultraviolet absorber (B) is preferably at most 20 parts by mass (particularly at most 10 parts by mass) per 100 parts by mass of the monomer (A).

As the ultraviolet absorber other than the polymerizable ultraviolet absorber (b-1), non-polymerizable ultraviolet absorber (hereinafter referred to as ultraviolet absorber (b-2)) is used. The proportion of the ultraviolet absorber other than the polymerizable ultraviolet absorber (b-1) is not particularly limited, and is preferably from 0 to 80 mass %, particularly preferably from 0 to 50 mass %, in the entire ultraviolet absorber (B).

The amount of use of the entire ultraviolet absorber (B) is preferably from 0.1 to 50 parts by mass, more preferably from 1 to 30 parts by mass per 100 parts by mass of the monomer (A). Although it varies depending upon the thickness of the insulating layer serving as a hardened coating film, when the total use amount is less than 0.1 part by mass, the weather resistance of the insulating layer itself decreases; whereas, when the total use amount exceeds 50 parts by mass, the curing properties and physical properties of the insulating layer deteriorate.

A polymerizable benzophenone compound is a compound having at least one (meth)acryloyl group and at least one benzophenone skeleton. Usually, a benzophenone compound having an ultraviolet absorbing power has at least one hydroxy group on at least one of two benzene rings in the benzophenone skeleton.

As specific examples of the polymerizable benzophenone compound, the following compounds may be mentioned.

2-Hydroxy-4-(meth)acryloyloxybenzophenone, 2-hydroxy-4-(2-(meth)acryloyloxyethoxy)benzophenone, 2-hydroxy-4-(2-acryloyloxypropoxyl)benzophenone, 2,2′-dihydroxy-4-(meth)acryloyloxybenzophenone and 2,2′-dihydroxy-4-(2-(meth)acryloyloxyethoxy)benzophenone.

A polymerizable benzotriazole compound is a compound having at least one (meth)acryloyl group and at least one benzotriazole ring. Usually, a benzotriazole compound having an ultraviolet absorbing power has a skeleton in which one benzene ring is bonded at the 2-position of a benzotriazole ring. That is, it comprises 2-phenyl benzotriazole as the skeleton. Further, it has a hydroxy group at the 2-position of the phenyl group. Preferred as the polymerizable benzotriazole compound is a 2-(2-hydroxyphenyl)benzotriazole having a (meth)acryloyl-containing group at the 5-position of the 2-hydroxyphenyl group.

As the ultraviolet absorber (b-2), a commercially available known ultraviolet absorber may be used. Such an ultraviolet absorber may, for example, be a benzotriazole type ultraviolet absorber, a benzophenone type ultraviolet absorber, a salicylic acid type ultraviolet absorber or a phenyl triazine type ultraviolet absorber.

### (The Photopolymerization Initiator (C))

The photopolymerization initiator (C) may, for example, be an aryl ketone type photopolymerization initiator (such as an acetophenone, a benzophenone, an alkylaminobenzophenone, a benzyl, a benzoin, a benzoin ether, a benzyldimethylketal, a benzoyl benzoate or an α-acyloxime ester), a sulfur-containing photopolymerization initiator (such as a sulfide or a thiaxanthone), an acylphosphine oxide (such as acyldiarylphosphine oxide) or another photopolymerization initiator. Such photopolymerization initiators may be used in combination of two or more. Further, the photopolymerization initiator may be used in combination with a photosensitizer such as an amine.

It is preferred that the amount of use of such a photopolymerization initiator (C) is from 0.1 to 20 parts by mass per 100 parts by mass of the monomer (A).

### (Other Components)

Further, in order to impart the water repellency to the insulating layer 5, a fluorinated polymerizable monomer (d-1) represented by the following formula (1) may be incorporated in the insulator composition of ultraviolet-cure type (i). As the fluorinated polymerizable monomer (d-1), fluorinated polymerizable monomers may be used alone or in combination with two or more.

CH₂═C(R¹)COOX¹R^{f} (1)

wherein R¹ is a hydrogen atom, a methyl group or a trifluoromethyl group, X¹ is a C1-6 bivalent organic group, and R^{f} is a C₄₋₆ perfluoroalkyl group.

As specific examples of the fluorinated polymerizable monomer (d-1) represented by the above formula (1), perfluorohexylethyl(meth)acrylate and perfluorobutylethyl(meth)acrylate may be mentioned.

By R^{f} being a C₄₋₆ perfluoroalkyl group, the fluorinated polymerizable monomer (d-1) is compatible with other components such as the polymerizable monomer (A), and when a coating film of the insulator composition (i) is hardened, the polymers will not coagulate with each other. In other words, the insulating layer 5 formed of a hardened product will have a favorable outer appearance without becoming cloudy, and adhesion between the insulating layer 5 and its underlayer (for example, the high-resistance layer 3) will be high. When R^{f} is a perfluoroalkyl group having at most 3 carbon atoms, the water repellency of the insulating layer 5 will deteriorate. In contrast, when R^{f} is a perfluoroalkyl group having at least 7 carbon atoms, the insulating layer 5 formed of a hardened product will become cloudy when the coating film is hardened and the adhesion between the insulating layer 5 and its underlayer (for example, the high-resistance layer 3) will decrease.

In the insulator composition of ultraviolet-cure type (i), as the case requires, a stabilizer such as an antioxidant, a photostabilizer or a thermal polymerization inhibitor, a surfactant such as a leveling agent, a defoaming agent, a thickener, an anti-settling agent, a pigment dispersant or an anti-fogging agent, a near infrared absorber, etc., may suitably be incorporated. Further, in order to further improve abrasion resistance of the hardened coating film, colloidal silica may be incorporated.

Further, in the insulator composition of ultraviolet-cure type (i), an organic solvent may be incorporated for the purpose of improving the coating properties of the coating film, or adhesion to the underlayer such as the high-resistance layer 3. The organic solvent is not particularly limited so long as it has no problem with solubility of the monomer (A), the ultraviolet absorber (B) and other additives, and any organic solvent which satisfies the above performance may be used. Further, at least two organic solvents may be used in combination. The amount of the organic solvent is properly at most 100 times by mass, particularly at most 50 times by mass, relative to the monomer (A).

The organic solvent may, for example, be an organic solvent such as a lower alcohol, a ketone, an ether or a cellosolve. In addition, an ester such as n-butyl acetate or diethylene glycol monoacetate, a haloganated hydrocarbon, a hydrocarbon or the like may also be used.

The insulating layer 5 made of a hardened product of the insulator composition of ultraviolet-cure type (i) may be formed by applying the insulator composition (i) containing the components on a laminate having the high-resistance layer 3 by a dip coating method, a flow coating method, a spray coating method, a bar coating method, a gravure coating method, a roll coating method, a blade coating method, an air knife coating method or a spin coating method, followed by drying in the case of a composition containing an organic solvent, and then irradiating the resulting film with ultraviolet light for curing.

For example, in a case where the insulator composition of ultraviolet-cure type (i) (hereinafter, the composition will be sometimes simply referred to as “insulator composition (i)”) is applied by a spin coating method, the insulator composition (i) is dropped on a laminate having the high-resistance layer 3, and a stage on which the laminate is placed and fixed is rotated at a predetermined number of revolutions, whereby a uniform thin film of the insulator composition (i) can be formed on the laminate.

Specifically, for example, in a case where the amount of the insulator composition (i) dropped on the laminate having the high-resistance layer 3 is about 1 cm³, it is preferred that the stage on which the laminate is placed is rotated at an initial number of revolutions of from 100 to 300 rpm for from about 10 to about 15 seconds, and then rotated at a maximum number of revolutions of from 1,500 to 2,500 rpm for from about 0.1 to about 1.0 second. In a case where the insulator composition (i) contains an organic solvent, the laminate after coating film formation is preferably maintained for example at a temperature range of from 100 to 150° C. for about 10 minutes to remove the organic solvent.

The ultraviolet light source may, for example, be a xenon lamp, a low pressure mercury lamp, a high pressure mercury lamp, an ultrahigh pressure mercury lamp, a metal halide lamp, a carbon arc lamp or a tungsten lamp. The irradiation time and the irradiation intensity with ultraviolet light may properly be changed depending upon conditions such as the type of the monomer (A), the type of the ultraviolet absorber (B), the type of the photopolymerization initiator (C), the coating film thickness and the ultraviolet light source. Curing can usually be made by irradiation of 1 to 60 seconds. Further, for the purpose of completing the curing reaction, heat treatment may be carried out after the irradiation with ultraviolet light.

The irradiation time and the irradiation intensity with ultraviolet light are preferably properly adjusted so that the energy integrated value is from about 500 to about 2,000 mJ/cm² and the peak value of the irradiation intensity becomes from 100 to 500 mW/cm².

In a case where the insulator composition of ultraviolet-cure type (i) is applied on the high-resistance layer 3 comprising an inorganic oxide including tin and titanium and hardened to form the insulating layer 5, the insulator composition (i) is applied preferably after a surface treatment (hereinafter, may be referred to also as an adhesion treatment) to increase the adhesion to the resin component is applied to the upper surface of the high-resistance layer 3, in order to increase the adhesion between the high-resistance layer 3 and the insulating layer 5.

For the adhesion treatment for improving the adhesion, the silane coupling agent may be used. As the silane coupling agent to be used for the adhesion treatment, for example, 3-aminopropyltrimethoxysilane, 3-aminopropylmethyldimethoxysilane, N-(2-aminoethyl)-3-aminopropylmethyldimethoxysilane, N-(2-aminoethyl)-3-aminopropyltrimethoxysilane, 3-glycidoxypropyltrimethoxysilane, 3-glycidoxypropyltriethoxysilane, 3-glycidoxypropylmethyldiethoxysilane, 3-methacryloxypropylmethyldimethoxysilane, 3-methacryloxypropyltrimethoxysilane and 3-acryloxypropyltrimethoxysilane may be mentioned.

The adhesion treatment may be carried out by applying a composition having the above silane coupling agent mixed with an organic solvent such as a lower alcohol, a ketone, an ether or a cellosolve to the upper surface of the high-resistance layer 3 by e.g. a dip coating method, a flow coating method, a spray coating method, a bar coating method, a gravure coating method, a roll coating method, a blade coating method, an air knife coating method or a spin coating method, followed by drying.

For example, in a case where the adhesion treatment on the upper surface of the high-resistance layer 3 is carried out by employing a spin coating method, a composition containing the above-described silane coupling agent is dropped on a laminate having the high-resistance layer 3, and a stage on which the laminate is placed and fixed is rotated at a predetermined number of revolutions to form a thin film of the composition containing the silane coupling agent on the upper surface of the laminate, whereby the adhesion treatment is conducted.

Specifically, in a case where the amount of the composition containing the silane coupling agent dropped on the upper surface of the high-resistance layer 3 is about 1 cm³, the stage on which the laminate is placed is rotated preferably at an initial number of revolutions of from 500 rpm to 1,500 rpm for from about 5 to about 15 seconds and then at a maximum number of revolutions of from 1,500 rpm to 2,500 rpm for from 0.1 to 1.0 second.

In a case where the composition used for the adhesion treatment contains an organic solvent, the laminate after the adhesion treatment is preferably maintained at from 100 to 150° C. for 30 minutes to remove the organic solvent.

By the insulating layer 5 being a layer formed by hardening the insulator composition of ultraviolet-cure type (i), the rate of formation of the insulating layer 5 is increased, whereby the efficiency for production of the front panel 10 for a tactile sensor can be improved.

<Insulator Composition of Heat-Cure Type (ii)>

The insulator composition of heat-cure type (ii) may, for example, be preferably one containing an aqueous/organic solvent dispersion (F) containing solid components comprising colloidal silica (f-1) and a partially condensed product (f-2) of an organoalkoxysilane.

The organoalkoxysilane is preferably methyltrimethoxysilane, methyltrihydroxysilane or a mixture thereof, which may form the partially condensed product (f-2). In addition, the organotrialkoxysilane may be tetraethoxysilane, ethyltriethoxysilane, diethyldiethoxysilane, tetramethoxysilane, methyltrimethoxysilane or dimethyldimethoxysilane.

The aqueous/organic solvent dispersion (F) may be produced specifically by adding a trialkoxysilane such as methyltrimethoxysilane to a commercially available aqueous dispersion of colloidal silica. Such an aqueous dispersion of colloidal silica may, for example, be “Ludox HS” (manufactured by DuPont), “Nalco” 1034A (manufactured by Nalco Chemical Co.).

The insulator composition of heat-cure type (ii) is preferably one produced by mixing an adhesion promoter (G) with the aqueous/organic solvent dispersion (F) containing an organoalkoxysilane as mentioned above, colloidal silica (f-1) and a sufficient amount of an alcohol. As the adhesion promoter (G), caprolactone based polyester polyol can be preferably used. In a case where the insulator composition of heat-cure type composition (ii) contains the above aqueous/organic solvent dispersion (F), the insulator composition (ii) preferably contains the adhesion promoter (G) comprising an acrylic polyol in an amount of from 1 to 10 parts by mass per 100 parts by mass of the aqueous/organic solvent dispersion (F) containing solid components comprising from 10 to 70 mass % of the colloidal silica (f-1) and from 30 to 90 mass % of the partially condensed product (f-2) of the organoalkoxysilane, in a proportion of from 10 to 50 mass %.

Here, the organoalkoxysilane may, for example, be one represented by the following formula (2):

(R¹⁰)ₐSi(OR¹¹)₄₋ₐ (2)

wherein R¹⁰ is a C₁₋₆ monovalent hydrocarbon group, R¹¹ is a C₁₋₆ monovalent hydrocarbon group or a hydrogen atom, and a is an integer of from 0 to 2.

In the insulator composition of heat-cure type (ii), an ultraviolet absorber can be incorporated. An ultraviolet absorber (H) to be incorporated in the insulator composition of heat-cure type (ii) is suitably one which co-reacts with a silane, and which will not substantially volatilize during the heat curing step. The ultraviolet absorber (H) may, for example, be 4[γ-(trimethoxysilyl)propoxy]-2, hydroxybenzophenone, 4[γ-(triethoxysilyl)propoxy]-2, hydroxybenzophenone or a mixture thereof. The ultraviolet absorber (H) may be incorporated at a concentration of from 2 to 20 mass % in the insulator composition of heat-cure type (ii).

In the insulator composition of heat-cure type (ii), another additive such as a free-radical initiator, a sterically hindered amine type photostabilizer, an antioxidant, a dye, a flowability-improving agent, a leveling agent or a surface lubricant may be further incorporated. Further, to shorten the curing time, as a catalyst, a tetrabutylammonium carboxylate catalyst such as tetra-n-butylammonium acetate (TBAA) or tetra-n-butylammonium formate may be incorporated.

The insulating layer 5 made of a hardened product of the insulator composition of heat-cure type (ii) may be formed by applying the above insulator composition (ii) onto a laminate having the high-resistance layer 3 by a known method such as a dip coating method, a flow coating method, a spray coating method, a bar coating method, a gravure coating method, a roll coating method, a blade coating method, an air knife coating method or a spin coating method, and curing the composition by heating at a temperature from 100 to 150° C. for from about 30 to about 90 minutes or by applying infrared or microwave energy.

For example, in a case where the insulator composition of heat-cure type (ii) (hereinafter sometimes referred to as the insulator composition (ii)) is applied by employing a spin coating method, the insulator composition (ii) is dropped on a laminate having the high-resistance layer 3, and a stage on which the laminate is placed and fixed is rotated at a predetermined number of revolutions, whereby a uniform thin film of the insulator composition (ii) can be formed on the upper surface of the laminate.

Specifically, for example, when the amount of the insulator composition (ii) dropped on the laminate having the high-resistance layer 3 is about 1 cm³, the stage on which the layered is placed and fixed is preferably rotated at an initial number of revolutions of from 100 to 300 rpm for from about 10 to about 15 seconds and then at a maximum number of revolutions of from about 1,500 to about 2,500 rpm for from 0.1 to 1.0 second.

By the insulating layer 5 being a layer formed by hardening the insulator composition of heat-cure type (ii), the rate of formation of the insulating layer 5 is increased, whereby the efficiency for producing the front panel 10 for a tactile sensor can be improved.

In a case where the insulating layer 5 is a layer formed by hardening the insulator composition of ultraviolet-cure type (i) or the insulator composition of heat-cure type (ii), the thickness of the insulating layer 5 is preferably 1 to 100 μm, more preferably 1 to 30 μm, further preferably 1 to 10 μm.

It is preferred that the thickness of the insulating layer 5 made of a hardened product of an insulator composition as mentioned above is at least 1 μm, since sufficient abrasion resistance and weather resistance can be obtained. When the thickness of the insulating layer 5 is at least 2 μm, the angle dependence of the reflected color can be reduced and excellent visibility can be obtained. On the other hand, it is preferred that the thickness of the insulating layer 5 made of a hardened product of the insulator composition is at most 100 μm, since curing will sufficiently proceed even at a deep portion of the insulating layer 5, whereby excellent light transmittance will be obtained, and in addition, sufficient bending strength of the front panel 10 for a tactile sensor can be obtained.

<Insulating Material Containing (iii) Inorganic Oxide as the Main Component>

The insulating layer 5 is not limited to a layer made of a hardened product of the organic insulator composition mentioned above. The insulating layer 5 can be formed of an insulating material containing an inorganic oxide having electrical insulating property i.e. the above-described volume resistivity, and having light transmittance, as the main component.

The insulating layer 5 comprising an insulating material containing an inorganic oxide as the main component may, for example, be a layer containing silicon oxide as the main component or a layer containing aluminum oxide as the main component. Among them, the insulating layer 5 containing silicon oxide as the main component is suitably used, since it can provide the front panel 10 for a tactile sensor having sufficient abrasion resistance and weather resistance while maintaining favorable light transmittance and low reflectance to visible light.

The layer containing silicon oxide as the main component may be a layer consisting solely of silicon oxide, or a layer containing silicon oxide as the main component and an element other than silicon, such as boron and phosphorus.

The insulating layer 5 containing such an inorganic oxide as the main component may be formed on the high-resistance layer 3 by a method such as DC sputtering such as DC magnetron sputtering, AC sputtering or RF sputtering, in the same manner as formation of the high-resistance layer 3.

In a case where the insulating layer 5 contains silicon oxide as the main component, the target to be used for forming the insulating layer 5 may be one consisting solely of silicon or one containing silicon as the main component doped with a known dopant such as boron or phosphorus.

Formation of the insulating layer 5 containing an inorganic oxide as the main component by sputtering may be carried out by properly adjusting conditions such as the pressure of the sputtering gas and the film deposition rate, in the same manner as sputtering for the high-resistance layer 3.

Further, the method for forming the insulating layer 5 containing an inorganic oxide as the main component is not limited to the sputtering method. For example, a physical vapor deposition method other than the sputtering method, such as a vacuum deposition method, an ion beam assisted deposition method or an ion plating method, or a chemical vapor deposition method such as a plasma CVD method can be used.

In a case where the insulating layer 5 is the above layer containing an inorganic oxide, its thickness is preferably 50 nm to 5 μm, more preferably at least 50 nm to 1 μm, further preferably at least 50 to 500 nm.

It is preferred that the thickness of the insulating layer 5 comprising an inorganic oxide is at least 50 nm, since sufficient abrasion resistance and weather resistance of the insulating layer 5 can be obtained. Further, when the thickness of the insulating layer 5 is at most 5 μm, the insulating layer 5 has a moderate bending strength and further has a sufficient light transmittance. Particularly, when the thickness of the insulating layer 4 is at most 500 nm, the angle dependence of the reflected color can be reduced, and excellent visibility will be obtained.

In the front panel 10 for a tactile sensor, the refractive index (n) of the insulating layer 5 is preferably from 1.3 to 1.8 with a view to obtaining excellent optical properties such as the luminous transmittance and the luminous reflectance.

### [Water Repellent Layer]

In a case where the insulating layer 5 contains no component to impart water repellency such as the above fluorinated polymerizable monomer (d-1), moisture which is brought into contact with the surface of the insulating layer 5 is likely to be diffused in and attached to the surface of the insulating layer 5. As a result, the electrostatic attraction (Coulomb force) working between the high-resistance layer 3 on which the electric charge is accumulated and the sensory receptor X such as a fingertip close to the surface layer of the insulating layer 5 will be blocked out, and accordingly no sufficient functions as a tactile sensor may be obtained. Accordingly, on the upper surface of an insulating layer 5 which does not contain a sufficient amount of a component to impart the water repellency, a water repellent layer 7 is preferably further formed as shown in FIG. 5. Specifically, a water repellent layer 7 is preferably formed on the upper surface of the insulating layer 5, in a case where the insulating layer 5 is a layer constituted by an insulating material containing an inorganic oxide as the main component. Particularly, it is more preferred to form a water repellent layer 7 on the upper surface of the insulating layer 5, when it is a layer containing a silicon oxide as the main component. By the constitution, sufficient functions as a tactile sensor can be obtained.

The water repellent layer 7 may be formed by a hardened product of a composition for forming a water repellent layer containing a fluorinated compound or a silicon-containing compound (hereinafter referred to as a water repellent agent).

The fluorinated compound or the silicon-containing compound is preferably a fluorinated silane coupling agent in view of the water repellency and the like, particularly preferably a silane coupling agent having a fluoroalkyl group. The fluoroalkyl group may, for example, be a perfluoroalkyl group or a fluoroalkyl group having a perfluoro(polyoxyalkylene) chain.

A commercially available silane coupling agent having a fluoroalkyl group may, for example, be AQUAPHOBE CF manufactured by Gelest, Inc., Novec EGC-1720 manufactured by Sumitomo 3M Limited, OPTOOL DSX manufactured by Daikin Industries, Ltd. (a silane coupling agent having a perfluoro(polyoxyalkylene) chain).

The water repellent layer 6 may be formed by applying the composition for forming a water repellent layer containing the above water repellent agent on the insulating layer 5, followed by heat treatment, or by vapor phase deposition of the water repellent agent on the upper surface of the insulating layer 5, followed by heat treatment. In a case where the water repellent layer 6 is formed by applying the composition for forming a water repellent layer, the coating method may, for example, be a spin coating method, a dip coating method, a casting method, a slit coating method or a spray coating method. The heat treatment temperature is preferably from 20 to 150° C., particularly preferably from 70 to 140° C. in view of productivity. The humidity may be controlled at the time of heat treatment so as to increase the reactivity of the water repellent agent.

In a case where the water repellent layer 6 is formed by vapor deposition of the composition for forming a water repellent layer, for example, the solvent is removed from the composition for forming a water repellent layer, the composition is heated to from 250 to 300° C. in a vacuum state, a laminate having the insulating layer 5 is put in an atmosphere of the water repellent agent in a vapor state, whereby gas molecules of the water repellent agent are attached to the surface of the laminate, whereby a uniform thin film of the water repellent agent can be formed on the upper surface of the laminate.

### [Transparent Electrodes 6a]

Transparent electrodes 6a′ (not shown) for driving a touch panel main body may be provided on the surface opposite to the surface of the transparent substrate 2 on which the high-resistance layer 3 is provided. The material constituting the transparent electrodes 6a and 6a′ may, for example, be tin-doped indium oxide (ITO), indium/gallium-doped zinc oxide (IGZO) or gallium-doped zinc oxide (GZO). Among them, ITO is preferred, in view of favorable transmittance, resistance stability and durability. The thickness of the transparent electrodes 6a is preferably from 50 to 500 nm, more preferably from 100 to 300 nm. When the thickness is at least 50 nm, a sufficient electric resistance will be obtained and in addition, the stability of the electric resistance can be secured. When it is at most 500 nm, a sufficient transmittance can be secured.

The transparent electrodes 6a and 6a′ are formed by first forming a film of a material serving as the transparent electrodes 6a on the surface of the transparent substrate 2 e.g. by a sputtering method or a deposition method and then, patterning the film into a desired shape e.g. by photolithography or laser patterning. In this manner, the transparent electrodes 6a can be formed.

The front panel 10 for a tactile sensor according to the second embodiment of the present invention preferably has the following properties.

### (Luminous Transmittance and Luminous Reflectance)

The luminous transmittance of the front panel 10 for a tactile sensor is preferably at least 85%. It is preferred that the luminous transmittance is at least 85%, since sufficient visibility can be obtained. The higher the luminous transmittance of the front panel 10 for a tactile sensor, the more preferable. In consideration of the transmittance of the material to be used, the upper limit of the luminous transmittance is 95%.

Further, the luminous reflectance of the front panel 10 for a tactile sensor is preferably at most 14%, more preferably at most 7%. Further for the reason that the screen is easily seen even under outside light, the luminous reflectance is preferably at most 2%, further preferably at most 1%.

### (Friction Coefficient)

The static friction coefficient of the front panel 10 for a tactile sensor is preferably at most 0.2, more preferably at most 0.15. Further, the dynamic friction coefficient of the front panel 10 for a tactile sensor is preferably at most 0.2, more preferably at most 0.15. Here, the static friction coefficient and dynamic friction coefficient are those of the surface layer constituting the front panel 10 for a tactile sensor.

When the static friction coefficient is at most 0.2, the front panel 10 for a tactile sensor having such a property that a finger can smoothly slide thereon can be obtained. In contrast, when the dynamic friction coefficient is at most 0.2, a large contrast can be obtained between the time of sliding a finger and the time of developing a sense of touch by voltage application. Accordingly, the front panel 10 for a tactile sensor providing a great sense of touch can be obtained.

### (Indentation Modulus)

The indentation modulus of the front panel 10 for a tactile sensor, which is evaluated by a microhardness measurement test, is preferably at least 2.5 GPa, more preferably at least 3.0 GPa.

When the indentation modulus is at least 2.5 GPa, the front panel 10 for a tactile sensor having durability sufficient for daily use can be obtained.

Here, “the microhardness measurement test” is a test method to calculate the hardness from the indentation depth, whereby the indentation modulus (GPa) corresponding to the indentation hardness can be measured. This hardness indicates “the hardness” of the front panel 10 for a tactile sensor, i.e. the mechanical strength such as the abrasion resistance.

### (Water Contact Angle)

The water contact angle of the front panel 10 for a tactile sensor is preferably at least 80 degrees, more preferably at least 90 degrees. When the contact angle is at least 80 degrees, a daily-use stain-resistant front panel 10 for a tactile sensor can be obtained.

Here, the water contact angle is measured on the surface layer of the front panel 1 for a tactile sensor by a contact angle meter.

According to such a front panel 10 for a tactile sensor, since the surface resistivity value of the high-resistance layer 3 is from 1 to 100 MΩ/□, a desired sense of touch can be developed with good reproducibility without electrical interaction between the high-resistance layer 3 and the transparent electrodes 6a or 6a′, and thus an excellent sensitivity of the tactile sensor will be obtained. In addition, the above range of the surface resistivity value is preferable since high luminous transmittance and excellent visibility can be obtained.

### EXAMPLES

Now, the present invention will be described in detail with reference to Examples.

### <Preparation of Composition for Forming Insulating Layer>

(Preparation of Ultraviolet Curable Resin A1) Into a 300 mL four-necked flask equipped with a stirrer, 163 g of butyl acetate first grade (manufactured by JUNSEI CHEMICAL CO., LTD.) and 41 g of 2-propanol were put, and 2 g of a reactive ultraviolet absorber (manufactured by Otsuka Chemical Co., Ltd., tradename: R-UVA93), 1 g of a photostabilizer (manufactured by BASF, tradename: TINUVIN292), 0.65 g of a leveling agent (manufactured by BYK Japan K.K., tradename: BYK306), 2.5 g of a photopolymerization initiator (manufactured by BASF, tradename: Irgacure907) and 0.1 g of a polymerization inhibitor hydroquinone monomethyl ether (manufactured by JUNSEI CHEMICAL CO., LTD.) were added thereto and dissolved.

Then, to this solution, 40 g of a multifunctional acrylate (manufactured by Shin-Nakamura Chemical Co., Ltd., tradename: U15HA), 60 g of a polyfunctional acrylate (manufactured by TOAGOSEI CO., LTD., tradename: M325) and 33 g of an acrylic resin (manufactured by MITSUBISHI RAYON CO., LTD., tradename: LR248) were added, stirred and dissolved at room temperature until the solution became uniform, thereby to obtain an ultraviolet curable resin A1 which is an insulator composition.

### (Preparation of Ultraviolet Curable Resin A2)

Into a 300 mL four-necked flask equipped with a stirrer, 163 g of butyl acetate first grade (manufactured by JUNSEI CHEMICAL CO., LTD.) and 41 g of 2-propanol were put, and 2 g of a reactive ultraviolet absorber (manufactured by Otsuka Chemical Co., Ltd., tradename: R-UVA93), 1 g of a photostabilizer (manufactured by BASF, tradename: TINUVIN292), 0.65 g of a leveling agent (manufactured by BYK Japan K.K., tradename: BYK306), 2.5 g of a photopolymerization initiator (manufactured by BASF, tradename: Irgacure907) and 0.1 g of a polymerization inhibitor hydroquinone monomethyl ether (manufactured by JUNSEI CHEMICAL CO., LTD.) were added thereto and dissolved.

Then, to this solution, 60 g of a multifunctional acrylate (manufactured by Shin-Nakamura Chemical Co., Ltd., tradename: U15HA), 40 g of a polyfunctional acrylate (manufactured by TOAGOSEI CO., LTD., tradename: M325), 1 g of a fluorinated acrylate (manufactured by Asahi Glass Company, Limited, tradename: C6FMA) and 17 g of an acrylic resin (manufactured by MITSUBISHI RAYON CO., LTD., tradename: LR248) were added, stirred and dissolved at room temperature until the solution became uniform, thereby to obtain an ultraviolet curable resin A2 which is an insulator composition.

### (Heat Curable Resin B1)

As an insulator composition of heat-cure type, a silicone hard coating agent of heat-cure type (manufactured by Momentive Performance Materials Inc., tradename: PHC587C) was used. Hereinafter, this silicone hard coating agent will be referred to as a heat curable resin B1.

### Example 1

A glass substrate (manufactured by Asahi Glass Company, Limited, tradename: AS glass, 100 mm×100 mm×1 mm in thickness) was put in a vacuum chamber, and the vacuum chamber was evacuated until the pressure in the chamber became 1×10⁻⁴ Pa. Subsequently, the substrate was heated by a heater and maintained at 200° C. Thereafter, a high-resistance layer a1 was formed by conducting a film formation treatment on the glass substrate in the following conditions to produce a high-resistance laminate.

That is, while a mixed gas having 2 vol % of an oxygen gas mixed with an argon gas was introduced, co-sputtering was carried out by a magnetron sputtering method under a pressure of 0.1 Pa using a tin oxide target (manufactured by AGC CERAMICS CO., LTD., tradename: GIT target) and a titanium oxide target (manufactured by AGC CERAMICS CO., LTD., tradename: TXO target).

With the GIT target, pulse sputtering was carried out under conditions of a frequency of 20 kHz, a power density of 3 W/cm² and a reverse pulse width of 5 μsec, and with the TXO target, pulse sputtering was conducted under conditions of a frequency of 20 kHz, a power density of 4 W/cm² and a reverse pulse width of 5 μsec. As a result, the high-resistance layer a1 comprising an oxide including tin and titanium and having a thickness of 20 nm was formed on the surface of the glass substrate to obtain a high-resistance laminate.

The atomic composition of the high-resistance layer a1 was analyzed by X-ray photoelectron spectrometer ESCA (manufactured by Physical Electronics, Inc., apparatus name: Quantera SXM). As a result, the atomic ratio of the tin to the titanium (Sn/Ti) was 90/10.

Then, on the high-resistance layer a1, an adhesion treatment was conducted by the following method.

First, 3-methacryloxypropyltrimethoxysilane (manufactured by Shin-Etsu Chemical Co., Ltd., tradename: KBM503) was diluted to 0.1 mass % with ethanol, about 1 cm³ of the diluted liquid was dropped on the surface of the high-resistance layer a1, and the laminate was rotated at a number of revolutions of 1,000 rpm for 10 seconds and then at 2,000 rpm for 0.5 second by a spin coater for coating. Then, the laminate was put in a constant temperature chamber and maintained at 120° C. for 30 minutes to cure the coating layer. In this manner, an adhesion treatment of the high-resistance layer a1 was conducted.

Then, an insulating layer b1 was formed by the following method.

First, about 1 cm³ of the ultraviolet curable resin A1 was dropped on the surface subjected to the adhesion treatment of the high-resistance layer a1, and then the laminate was rotated at a number of revolutions of 200 rpm for 10 second and then at 2,000 rpm for 0.5 second by a spin coater to form a coating film. Then, the laminate was put and maintained at 120° C. for 10 minutes to dry the coating film.

Then, the high-resistance laminate having a dried coating film of ultraviolet curable resin A1 formed thereon was irradiated with ultraviolet light by using an UV irradiation apparatus provided with a conveyor (manufactured by USHIO INC., apparatus name: UVC-02516S1) while the transfer rate and the UV intensity were adjusted so that the UV irradiation integrated value became 1,000 mJ/cm² and the peak value became 375 mW/cm², to cure the coating film, thereby to form an insulating layer b1 made of a hardened product of the ultraviolet curable resin A1. The thickness of the insulating layer b1 was 10 μm.

In such a manner, a front panel 1 for a tactile sensor comprising the high-resistance layer a1 and the insulating layer b1 layered on the glass substrate was obtained.

### Example 2

In the same manner as in Example 1 except that the ultraviolet curable resin A2 was used instead of the ultraviolet curable resin A1 as the insulator composition, a front panel 2 for a tactile sensor comprising a high-resistance layer a1 having a thickness of 20 nm and an insulating layer b2 having a thickness of 10 μm layered on the glass substrate was obtained.

### Example 3

In the same manner as in Example 1, a high-resistance layer a1 was formed upon the glass substrate. On the high-resistance layer a1, without an adhesion treatment, an insulating layer b3 was formed as follows.

That is, about 1 cm³ of the heat curable resin B1 was dropped on the high-resistance layer a1, and the laminate was rotated at a number of revolutions of 200 rpm for 10 seconds and then at 2,000 rpm for 0.5 second by a spin coater, and then put in a constant temperature chamber and maintained at 120° C. for 60 seconds to thermally cure the heat curable resin B1, thereby to form an insulating layer b3. The thickness of the insulating layer b3 was 5 μm.

In such a manner, a front panel 3 for a tactile sensor comprising the high-resistance layer a1 and the insulating layer b3 layered on the glass substrate was obtained.

### Example 4

The glass substrate (manufactured by Asahi Glass Company, Limited, tradename: AS glass, 100 mm×100 mm×1 mm in thickness) was put in a vacuum chamber, and the vacuum chamber was evacuated until the pressure in the chamber became 1×10⁻⁴ Pa. The substrate was heated by a heater and maintained at 200° C. Then, a film deposition treatment was carried out on the glass substrate under the following conditions to form a barrier layer c1 and a high-resistance layer a1 in order.

First, while a mixed gas having 40 vol % of an oxygen gas mixed with an argon gas was introduced, pulse sputtering was carried out by using a Si target under conditions of a pressure of 0.3 Pa, a frequency of 20 kHz, a power density of 3.8 W/cm and a reverse pulse width of 5 μsec, to form a barrier layer c1 having a thickness of 20 nm comprising silicon oxide on the surface of the glass substrate.

Then, on the barrier layer c1, in the same manner as in Example 1, a high-resistance layer a1 having a thickness of 20 nm was formed. In such a manner, a high-resistance laminate having two layers; i.e., the barrier layer c1 and the high-resistance layer a1, layered on the glass substrate was obtained.

Then, an adhesion treatment was conducted on the high-resistance layer a1 of the high-resistance laminate thus obtained in the same manner as in Example 1, and then an insulating layer b2 having a thickness of 10 μm was formed in the same manner as in Example 2 to obtain a front panel 4 for a tactile sensor.

### Example 5

On the glass substrate (manufactured by Asahi Glass Company, Limited, tradename: AS glass, 100 mm×100 mm×1 mm in thickness), in the same manner as in Example 4, a barrier layer c1 having a thickness of 20 nm was formed. Then, in the same manner as in Example 1 except that the power density in the pulse sputtering by the GIT target was changed from 3 W/cm² to 3.8 W/cm², co-sputtering was carried out by a magnetron sputtering method. In such a manner, high-resistance layer a2 comprising an oxide including tin and titanium and having a thickness of 20 nm was formed upon the barrier layer c1 to obtain a high-resistance laminate.

The atomic composition of the high-resistance layer a2 was analyzed by ESCA (Physical Electronics, Inc., apparatus name: Quantera SXM) and as a result, the atomic ratio of the tin to the titanium (Sn/Ti) was 93/7.

Then, while a mixed gas having 40 vol % of an oxygen gas mixed with an argon gas was introduced, pulse sputtering was carried out using a Si target under conditions of a pressure of 0.3 Pa, a frequency of 20 kHz, a power density of 3.8 W/cm² and a reverse pulse width of 5 μsec to form an insulating layer b4 having a thickness of 100 nm comprising silicon oxide on the high-resistance layer a2.

Then, on the insulating layer b4, a water repellent layer d1 was formed by the following method. First, in a crucible as a heating container, 75 g of OPTOOL DSX (tradename, manufactured by Daikin Industries, Ltd.) as a deposition material was put, and the crucible was evacuated by a vacuum pump for at least 10 hours to remove the solvent.

Thereafter, the crucible was heated in the vacuum chamber until the temperature in the crucible reached 270° C. and further maintained for about 10 minutes until the temperature in the crucible was stabilized, and then the laminate comprising the barrier layer c1, the high-resistance layer a2 and the insulating layer b4 formed upon the glass substrate in the stated order, was introduced into the vacuum chamber to carry out film formation by deposition of the depositing material. In such a manner, a water repellent layer d1 having a thickness of 15 nm was formed on the insulating layer b4, thereby to obtain a front panel 5 for a tactile sensor.

### Example 6

The glass substrate (manufactured by Asahi Glass Company, Limited, tradename: AS glass, 100 mm×100 mm×1 mm in thickness) was put in a vacuum chamber, the vacuum chamber was evacuated until the pressure in the chamber became 1×10⁻⁴ Pa, and then a film formation treatment was conducted on the glass substrate under the following conditions to form a barrier layer c2 and a high-resistance layer a3 in order and obtain a high-resistance laminate.

First, while a mixed gas having 5 vol % of an oxygen gas mixed with an argon gas was introduced, pulse sputtering was carried out by using a target having 30 mass % of silicon oxide mixed with indium oxide, under conditions of a pressure of 0.3 Pa, a frequency of 20 kHz, a power density of 3.8 W/cm² and a reverse pulse width of 5 μsec, to form a barrier layer c2 having a thickness of 70 nm comprising silicon oxide and indium oxide on the surface of the glass substrate.

Then, co-sputtering was carried out by a magnetron sputtering method in the same manner as in Example 1 except that the gas to be introduced into the vacuum chamber was changed from the mixed gas in Example 1 having 2 vol % of an oxygen gas mixed with an argon gas to a mixed gas having 5 vol % of an oxygen gas mixed with an argon gas, and that the power density in the pulse sputtering using the GIT target was changed from 3 W/cm² to 3.8 W/cm². In such a manner, a high-resistance layer a3 having a thickness of 100 nm comprising an oxide including tin and titanium was formed upon the barrier layer c2.

The atomic composition of this high-resistance layer a3 was analyzed by ESCA (manufactured by Physical Electronics Inc., apparatus name: Quantera SXM) and as a result, the atomic ratio of the tin to the titanium (Sn/Ti) was 93/7.

Then, on the high-resistance layer a3, in the same manner as in Example 5, an insulating layer b4 having a thickness of 90 nm comprising silicon oxide was formed, and on the insulating layer b4, a water repellent layer d1 having a thickness of 15 nm was formed in the same manner as in Example 5. In such a manner, a front panel 6 for a tactile sensor comprising the barrier layer c2, the high-resistance layer a3, the insulating layer b4 and the water repellent layer d1 layered on the glass substrate in the stated order was obtained.

### Example 7

In the same manner as in Example 5 except that the thickness of the insulating layer was 1 μm, a barrier layer c1 having a thickness of 20 nm, a high-resistance layer a2 having a thickness of 20 nm, an insulating layer b4 having a thickness of 1 μm and a water repellent layer d1 having a thickness of 15 nm were layered on the glass substrate in the stated order to obtain a front panel 7 for a tactile sensor.

### Example 8

In the same manner as in Example 4 except that a chemically reinforced aluminasilicate glass substrate (100 mm×100 mm×0.8 mm in thickness) was used as a glass substrate instead of the AS glass, a front panel 8 for a tactile sensor was obtained. The glass material for the glass substrate used herein had a composition containing 64.5% of SiO₂, 8% of Al₂O₂, 12.5% of Na₂O, 4% of K₂O, 10.5% of MgO, 0.1% of CaO, 0.1% of SrO, 0.1% of BaO and 0.5% of ZrO₂ (the percentages of these oxides are represented by mol %). The chemical tempering treatment was carried out by immersing the aluminasilicate glass plate in a KNO₃ molten salt to carry out ion exchange treatment and then cooling the glass plate to the vicinity of room temperature. Of the obtained tempered glass, the surface compressive stress was 735 MPa, and the thickness of the compressive stress layer was 51.2 μm. The surface compressive stress and the thickness of the compressive stress layer were measured by a surface compressive stress meter (manufactured by Orihara Manufacturing Co., Ltd., apparatus name: FSM-6000).

### Example 9

In the same manner as in Example 5 except that the same chemically tempered aluminosilicate glass substrate as used in Example 8 was used as a glass substrate instead of the AS glass, a front panel 9 for a tactile sensor was obtained.

### Reference Example 1

On a glass substrate (manufactured by Asahi Glass Company, Limited, tradename: AS glass, 100 mm in length×100 mm in width×1 mm in thickness), a barrier layer c1 having a thickness of 20 nm was formed in the same manner as in Example 4.

Subsequently, while a mixed gas having 0.6 vol % of an oxygen gas mixed with an argon gas was introduced, co-sputtering was carried out by a magnetron sputtering method under a pressure of 0.1 Pa using a tin oxide target (manufactured by AGC CERAMICS CO., LTD, tradename: GIT target) and a niobium oxide target (manufactured by AGC CERAMICS CO., LTD, tradename: NBO target).

With the GIT target, pulse sputtering was carried out under conditions of a frequency of 20 kHz, a power density of 3 W/cm² and a reverse pulse width of 5 μsec, and with the NBO target, pulse sputtering was conducted under conditions of a frequency of 20 kHz, a power density of 1 W/cm² and a reverse pulse width of 5 μsec. As a result, a high-resistance layer a5 comprising an oxide including tin and niobium and having a thickness of 20 nm was formed upon the barrier layer c1 to produce a high-resistance laminate.

Subsequently, insulating layer b1 having a thickness of 10 μm was formed upon the high-resistance layer a5 in the same manner as in Example 1.

In such a manner, the barrier layer c1, high-resistance film a5 and insulating layer b1 were layered on the glass substrate in the stated order to obtain the front panel 10 for a tactile sensor.

### Reference Example 2

On a glass substrate (manufactured by Asahi Glass Company, Limited, tradename: AS glass, 100 mm in length×100 mm in width×1 mm in thickness), a barrier layer c1 having a thickness of 20 nm was formed in the same manner as in Example 4.

Subsequently, while a mixed gas having 1 vol % of an oxygen gas mixed with an argon gas was introduced, co-sputtering was carried out by a magnetron sputtering method under a pressure of 0.1 Pa using a tin oxide target (manufactured by AGC CERAMICS CO., LTD, tradename: GIT target) and a zirconium target.

With the GIT target, pulse sputtering was carried out under conditions of a frequency of 20 kHz, a power density of 3 W/cm² and a reverse pulse width of 5 μsec, and with the Zr target, pulse sputtering was carried out under conditions of a frequency of 20 kHz, a power density of 0.5 W/cm² and a reverse pulse width of 5 μsec. As a result, a high-resistance layer a6 comprising an oxide including tin and zirconium and having a thickness of 20 nm was formed upon the barrier layer c1 to produce a high-resistance laminate.

Subsequently, insulating layer b1 having a thickness of 10 μm was formed upon the high-resistance layer a6 in the same manner as in Example 1.

In such a manner, the barrier layer c1, high-resistance film a5 and insulating layer b1 were layered on the glass substrate in the stated order to obtain the front panel 11 for a tactile sensor.

### Comparative Example

On the glass substrate (manufactured by Asahi Glass Company, Limited, tradename: AS glass, 100 mm×100 mm×1 mm in thickness), in the same manner as in Example 4, a barrier layer c1 having a thickness of 20 nm was formed.

Then, while a mixed gas having 2 vol % of an oxygen gas mixed with an argon gas was introduced, pulse sputtering was carried out by a magnetron sputtering method by using a target having 50 mass % of indium oxide mixed with gallium oxide (manufactured by Sumitomo Metal Mining Co., Ltd., tradename: GIO target) under conditions of a pressure of 0.1 Pa, a frequency of 20 kHz, a power density of 0.8 W/cm² and a reverse pulse width of 5 μsec. As a result, a high-resistance layer a4 constituted of an oxide including gallium and indium and having a thickness of 15 nm was formed upon the surface of the glass substrate to produce a high-resistance laminate.

The atomic composition of the high-resistance layer a4 was analyzed by ESCA (manufactured by Physical Electronics, Inc., apparatus name: Quantera SXM) and as a result, the atomic ratio of gallium to indium (Ga/In) was 60/40.

Then, on the high-resistance layer a4, an adhesion treatment was conducted in the same manner as in Example 1, and then an insulating layer b1 made of a hardened product of the ultraviolet curable resin A1 was formed, to obtain a front panel 12 for a tactile sensor.

Of the front panels 1 to 12 for a tactile sensor obtained in Examples 1 to 9, Reference Examples 1 and 2, and Comparative Example, the luminous transmittance, the luminous reflectance, the surface resistivity value of the high-resistance layer, the sensitivity of the tactile sensor, the indentation modulus, the angle dependence of the reflected color, the static friction coefficient, the dynamic friction coefficient and the water contact angle were measured respectively by the following methods. The constitution and thickness of each of the front panels 1 to 12 for a tactile sensor are shown in Table 1 and the evaluation results of the properties are shown in Table 2.

### (Luminous Transmittance)

The transmittance of each of the front panels 1 to 12 for a tactile sensor was measured by a spectrophotometer (manufactured by Shimadzu Corporation, apparatus name: SolidSpec-3700). From the transmittance, the stimulus value Y specified by JIS 28701 was calculated. Then, the stimulus value Y was regarded as the luminous transmittance.

### (Luminous Reflectance)

The reflectance of each of the front panels 1 to 12 for a tactile sensor was measured by a spectrophotometer (manufactured by Shimadzu Corporation, model: UV3150PC), and from the reflectance, the stimulus value Y of reflection as specified by JIS 28701 was obtained. Then, the stimulus value Y was regarded as the luminous reflectance. In order to cancel out the back (side) reflection of the front panel, the rear side of the glass substrate was painted in black to carry out measurement.

### (Surface Resistivity Value)

After the high-resistance layer of the laminate was formed, the surface resistivity value of the high-resistance layer was measured by a measuring apparatus (manufactured by Mitsubishi Chemical Analytech Co., Ltd., apparatus name: Hiresta UP (MCP-HT450 model)). A probe was applied to the center of the 10 cm square sample and electricity was applied at 10 V for 10 seconds for measurement.

### (Sensitivity of Tactile Sensor)

A copper conductive tape was bonded to four sides on the rear surface of a glass plate in each of the front panels 1 to 12 for a tactile sensor, and a voltage of 2 kV was applied at a frequency of about 400 Hz. The surface of each of the front panels for a tactile sensor to which electricity was applied, was traced with a fingertip, and tactile sensor sensitivity was evaluated by the level of the sense of tactile perceived by the fingertip.

In Table 2, o represents that the sense of tactile was clearly perceived by the fingertip, and x represents that no sense of tactile was perceived by the fingertip, or even if perceived, it was very weak, or the sense of tactile perceived by the fingertip was so intense that the fingertip was excessively stimulated, and no appropriate sensor sensitivity was obtained.

When the voltage was applied from the conductive tape (a polyethylene terephthalate film (10 μm in thickness) was attached to copper foil) provided on the rear surface of the front panel for a tactile sensor while adjusting the applied voltage within the range of 750 V to 100 kV, a sense of tactile was developed at an application voltage of about 2 kV, and thus, sensor sensitivity was evaluated based on this voltage value.

### (Indentation Modulus)

The indentation modulus (GPa) of each of the front panels 1 to 12 for a tactile sensor was measured by using a microhardness testing machine (manufactured by Fischer Instruments, apparatus name: PICODENTOR HM500) in accordance with ISO14577. For measurement, a Vickers indenter was used.

### (Angle Dependence of Reflected Color)

The rear side of the glass substrate was painted in black to cancel out the back (side) reflection, and such front panels 1 to 12 for a tactile sensor were placed on a table, and a daylight straight tube fluorescent desk lamp (manufactured by NEC Corporation, three wavelength neutral white) was disposed with a height of 40 cm from the table. Under the light from the fluorescent lamp, the surface of each of the front panels 1 to 12 for a tactile sensor was visually observed from various angles, and the change in the color tone of the reflected light depending upon the visual observation angle was evaluated. The angle dependence was evaluated based on standards o: the color tone of the front panel surface was monochromatic (mainly blue or the like) when visually observed from any angle, or the change in the color tone was gradual even when the visual observation angle was changed by over 10 degrees, and x: the color tone of the front panel surface was changed when the visual observation angle was changed within a range of at most 10 degrees.

### (Dynamic Friction Coefficient)

Of the front panels 1 to 12 for a tactile sensor, the dynamic friction coefficient was measured by using a surface property measuring machine (manufactured by Shinto Scientific Co., Ltd., model: Type 38) under the following conditions.

First, a wiper (manufactured by Asahi Kasei Corporation, tradename: “BEMCOT” (registered trademark)) was fixed to an indenter (the area of contact with a sample: 10 mm×30 mm), and then the indenter was brought into contact with the front panel placed on a stage of the measuring machine. In a state where a load of 500 g was applied to the indenter, the stage on which the front panel was placed was moved so that the front panel surface was slid five times with a sliding rate of 500 mm/min with a stroke of 20 mm, and the friction was measured by strain gauge at the bottom of the indenter. The average of coefficients of friction calculated from the measured values of the friction and the load applied to the indenter, was regarded as the dynamic friction coefficient.

### (Static Friction Coefficient)

In the front panels 1 to 12 for a tactile sensor, using the same apparatus for measurement of the dynamic friction coefficient except that the indenter used for measurement of the dynamic friction coefficient was changed to an iron ball, the front panel surface was slid under the same conditions, and the friction coefficient calculated from the friction measured when the iron ball started to slide was regarded as the static friction coefficient.

### (Water Contact Angle)

About 1 μL of a pure water droplet was placed on the surface of each of the front panels 1 to 12 for a tactile sensor, and the water contact angle was measured by a contact angle meter (manufactured by Kyowa Interface Science Co., Ltd., apparatus name: DM-051).

TABLE 1

| | High-resistance layer | | Barrier layer | | Insulating layer | | Water repellent layer | |
|---|---|---|---|---|---|---|---|---|
| | Layer | Thick- | Layer | Thick- | Layer | Thick- | | Thick- |
| | constitution | ness | constitution | ness | constitution (con- | ness | Layer | ness |
| | (target) | [nm] | (target) | [nm] | stituting material) | [μm] | constitution | [nm] |
| Example 1 | a1 | 20 | — | — | b1 | 10 | — | — |
| | (Tin oxide/ | | | | (Ultraviolet curable | | | |
| | titanium oxide) | | | | resin A1) | | | |
| Example 2 | a1 | 20 | — | — | b2 | 10 | — | — |
| | (Tin oxide/ | | | | (Ultraviolet curable | | | |
| | titanium oxide) | | | | resin A2) | | | |
| Example 3 | a1 | 20 | — | — | b3 | 5 | — | — |
| | (Tin oxide/ | | | | (Heat curable | | | |
| | titanium oxide) | | | | resin B1) | | | |
| Example 4 | a1 | 20 | c1 | 20 | b2 | 10 | — | — |
| | (Tin oxide/ | | (Si) | | (Ultraviolet curable | | | |
| | titanium oxide) | | | | resin A2) | | | |
| Example 5 | a2 | 20 | c1 | 20 | b4 | 0.1 | d1 | 15 |
| | (Tin oxide/ | | (Si) | | (Si target) | | | |
| | titanium oxide) | | | | | | | |
| Example 6 | a3 | 100 | c2 | 70 | b4 | 0.09 | d1 | 15 |
| | (Tin oxide/ | | (Indium oxide/ | | (Si target) | | | |
| | titanium oxide) | | silicon oxide) | | | | | |
| Example 7 | a2 | 20 | c1 | 20 | b4 | 1 | d1 | 15 |
| | (Tin oxide/ | | (Si) | | (Si target) | | | |
| | titanium oxide) | | | | | | | |
| Example 8 | c1 | 20 | c1 | 20 | b2 | 10 | — | — |
| | (Tin oxide/ | | (Si) | | (Ultraviolet curable | | | |
| | titanium oxide) | | | | resin A2) | | | |
| Example 9 | a2 | 20 | c1 | 20 | b4 | 0.1 | d1 | 15 |
| | (Tin oxide/ | | (Si) | | (Si target) | | | |
| | titanium oxide) | | | | | | | |
| Reference | a5 | 20 | c1 | 20 | b1 | 10 | | |
| Example 1 | (Tin oxide/ | | (Si) | | (Ultraviolet curable | | | |
| | niobium oxide) | | | | resin A1) | | | |
| Reference | a6 | 20 | c1 | 20 | b1 | 10 | | |
| Example 2 | (Tin oxide/ | | (Si) | | (Ultraviolet curable | | | |
| | zirconium oxide) | | | | resin A1) | | | |
| Comparative | a4 | 15 | c1 | 20 | b1 | 10 | — | — |
| Example | (Gallium oxide/ | | (Si) | | (Ultraviolet curable | | | |
| | indium oxide) | | | | resin A1) | | | |

TABLE 2

| | Luminous | Lumi- | Surface | Tactile | Inden- | Angle | Static | Dynamic | Water |
|---|---|---|---|---|---|---|---|---|---|
| | trans- | nous re- | resistivity | sensor | tation | dependence | friction | friction | contact |
| | mittance | flectance | value | sensi- | modulus | of reflect- | coeffi- | coeffi- | angle |
| | [%] | [%] | [MΩ/□] | tivity | [GPa] | ed color | cient | cient | [degree] |
| Example 1 | 90 | 7 | 50 | ∘ | 3.8 | ∘ | 0.10 | 0.09 | 90 |
| Example 2 | 90 | 7 | 50 | ∘ | 3.8 | ∘ | 0.13 | 0.09 | 92 |
| Example 3 | 90 | 7 | 50 | ∘ | 4.5 | ∘ | 0.13 | 0.09 | 92 |
| Example 4 | 90 | 7 | 48 | ∘ | 3.8 | ∘ | 0.13 | 0.09 | 90 |
| Example 5 | 94 | 0.5 | 48 | ∘ | 55.8 | ∘ | 0.13 | 0.07 | 112 |
| Example 6 | 94 | 0.5 | 12 | ∘ | 55.8 | ∘ | 0.13 | 0.07 | 112 |
| Example 7 | 90 | 7 | 48 | ∘ | 55.8 | x | 0.13 | 0.07 | 110 |
| Example 8 | 90 | 7 | 48 | ∘ | 3.8 | ∘ | 0.13 | 0.09 | 111 |
| Example 9 | 94 | 0.5 | 48 | ∘ | 55.8 | ∘ | 0.13 | 0.07 | 112 |
| Reference | 90 | 7 | 65 | ∘ | 3.8 | ∘ | 0.10 | 0.09 | 90 |
| Example 1 | | | | | | | | | |
| Reference | 90 | 6 | 32 | ∘ | 3.8 | ∘ | 0.10 | 0.09 | 90 |
| Example 2 | | | | | | | | | |
| Comparative | 80 | 15 | 0.7 | x | 3.8 | ∘ | 0.13 | 0.09 | 110 |
| Example | | | | | | | | | |

As evident from Table 2, in Examples 1 to 9, since high-resistance layer comprising an oxide including tin and titanium as main components, an atomic ratio of Sn/Ti within the predetermined range (80/20 to 95/5) and a surface resistivity value of 1 to 100 MΩ/□ is provided, favorable sensor sensitivity was obtained. In addition, the luminous transmittance is at least 85% and the luminous reflectance is at most 7%, whereby excellent visibility was obtained.

Also in the cases in Reference Examples 1 and 2 where high-resistance layers having an oxide including tin and niobium and an oxide including tin and zirconium as main components, respectively and a surface resistivity value of 1 to 100 MΩ/□ were provided, favorable sensor sensitivity was obtained. From these results, it is considered that titanium, niobium and zirconium in a tin oxide all function as a scattering substance for electrons in the tin oxide and the mean free path of electrons in tin oxide serving as a material for a transparent conducting film is shortened, with the result that high-resistance can be attained. However, in the case where the high-resistance layer is formed of tin and the above elements in combination, targets containing individual elements are required. In forming a target, a combination of tin and titanium can be relatively easily formed. Likewise, in consideration of productivity of the high-resistance layer and the like, a high-resistance layer comprising an oxide including tin and titanium as main components is preferred.

In contrast, in Comparative Example, the high-resistance layers are not constituted of an oxide including tin and titanium and have a surface resistivity value of 0.7Ω/□. Thus, the sensor sensitivity is favorable; however, luminous transmittance is less than 85% and luminous reflectance exceeds 7%, whereby visibility is poor.

### INDUSTRIAL APPLICABILITY

According to the high-resistance laminate and front panel for a tactile sensor of the present invention, favorable sensor sensitivity capable of sensing by touch can be realized, and a useful touch panel display device is provided.

The entire disclosure of Japanese Patent Application No. 2011-283809 filed on Dec. 26, 2011 including the specification, claims, drawings and summary is incorporated herein by reference in its entirety.

### REFERENCE SIGNS LIST

1 . . . High-resistance laminate, 2 . . . Transparent substrate, 3 . . . High-resistance layer, 4 . . . Barrier layer, 5 . . . Insulating layer, 6 . . . Touch panel main body, 7 . . . Water repellent layer, 10 . . . Front panel for tactile sensor.

1. A high-resistance laminate comprising a transparent substrate and a high-resistance layer formed upon the transparent substrate,
wherein the high-resistance layer comprises an oxide including tin and titanium as main components,
wherein the atomic ratio of the tin to the titanium (Sn/Ti) is 80/20 to 95/5, and the surface resistivity value of the high-resistance layer is 1 to 100 M Ω/□.

2. The high-resistance laminate according to claim 1, wherein a barrier layer is interposed between the transparent substrate and the high resistance layer.

3. A front plate for a tactile sensor wherein a high-resistance layer and an insulation layer are layered on a transparent substrate in the stated order,
wherein the high-resistance layer comprises an oxide including tin and titanium as main components,
wherein the atomic ratio of the tin to the titanium (Sn/Ti) is 80/20 to 95/5, and the surface resistivity value of the high-resistance layer is between 1 and 100M ohm/square.

4. The front plate for tactile sensor according to claim 3, wherein the luminous transmittance is at least 85%.

5. The front plate for tactile sensor according to claim 3 or 4, wherein a barrier layer is interposed between the transparent substrate and the high resistance layer.

6. The front plate for tactile sensor according to any one of claims 3 to 5, wherein the static friction coefficient is at most 0.2.

7. The front plate for tactile sensor according to any one of claims 3 to 6, wherein the dynamic friction coefficient is at most 0.2.

8. The front plate for tactile sensor according to any one of claims 3 to 7, wherein the water contact angle is at least 80 degrees

9. The front plate for tactile sensor according to any one of claims 3 to 8, wherein the luminous reflectance is at most 7%.

10. The front plate for tactile sensor according to any one of claims 1 to 9, wherein the refraction index of the high resistance layer is 1.8 to 2.5, and the thickness of the high resistance layer is 5 to 50 nm.

11. The front plate for tactile sensor according to any one of claims 3 to 10, wherein the refraction index of the insulation layer is 1.3 to 1.8.

12. The front plate for tactile sensor according to any one of claims 3 to 11, wherein the material of the insulation layer is inorganic oxide and the thickness of the insulation layer is 50 nm to 5 μm.

13. The front plate for tactile sensor according to any one of claims 3 to 11, wherein the insulation layer is a layer formed by hardening an insulator composition of ultraviolet-cure type or an insulator composition of heat-cure type and the thickness of the insulation layer is 1 to 100 μm.
